(19) United States
(12) Patent Application Publication
(10) Pub. No.: US 2013/0292921 A1
(43) Pub. Date: Nov. 7, 2013

(54) Repositionable Bike Stand

(71) Applicant: Terry Vanderschuur, Greenwood, CA (US)

(72) Inventor: Terry Vanderschuur, Greenwood, CA (US)

(21) Appl. No.: 13/869,096

(22) Filed: Apr. 24, 2013

Related U.S. Application Data
(60) Provisional application No. 61/641,357, filed on May 2, 2012.

(51) Int. Cl. B62H 1/04

(52) U.S. Cl. CPC B62H 1/04
USPC 280/299

(57) ABSTRACT

A bicycle stand device that may be removably attached to the axle of a traditional bicycle and easily repositioned between a bicycle stand or stationary bicycle stand position and a stored position. In a preferred embodiment of the present invention, the bicycle stand device is comprised of at least one axle extender for attachment to a bicycle axle, a bicycle stand for attachment to said at least one axle extender, and a repositioning pin for repositioning said bicycle stand between a stationary bicycle stand position and a stored position without removing the device from the bicycle. The device enables a user to combine the function of a traditional bicycle with that of a stationary bicycle, and eliminates the need for the user to own two bicycles and the expense and storage requirements associated therewith.

### CROSS-REFERENCE

This application claims priority from Provisional Patent Application Ser. No. 61/641,357 filed on May 2, 2012.

### FIELD OF THE INVENTION

This invention relates to a repositionable bicycle stand that allows the bicycle to be used in both a traditional manner or a stationary manner, and is also capable of supporting the bicycle in a generally upright position when not in use.

### BACKGROUND

Many bicycles do not include a bicycle stand when purchased. Therefore, the owner may attempt to lean the bicycle against a wall or other structure when not in use. However, this may cause the bicycle frame or other bicycle component to become scratched or damaged, particularly if the bicycle falls over onto the ground. Other bicycle owners will purchase a kickstand and attach the same to one side of the bicycle to prop-up or support the bicycle when not in use. However, to be effective, kickstands typically require that the bicycle lean to one side which may also result in the bicycle falling over and becoming damaged. In addition, kickstands only perform a single function, namely supporting a bicycle that is not in use.

Furthermore, many people rely upon bicycles for exercise, enjoyment and/or rehabilitation purposes (e.g., using a stationary bicycle to increase an individuals range of motion after a knee or hip replacement). However, many geographical areas do not have climate or weather patterns that are conducive to year round outdoor bicycle riding. To overcome such limitations, many bicycle riders are forced to purchase an additional bicycle for indoor use, such as a stationary bicycle. However, owning and having to store two bicycles, namely an outdoor bicycle and an indoor stationary bicycle, can be both expensive and cumbersome, and require too much storage space. Others have attempted to attach a stand to an existing outdoor bicycle to elevate the rear wheel of the bicycle so that it can be used as a stationary bicycle, but such stands are both difficult and time-consuming to install and remove from a traditional bicycle and tend to discourage bicycle enthusiast from employing the same.

Consequently, there is a long felt need in the art for a bicycle stand device that can be removably attached to a prior art bicycle and easily repositioned between a bicycle stand or stationary bicycle stand position and a stored position, without having to remove the device from the bicycle. There is also a long felt need for a bicycle stand device that is capable of securely supporting a bicycle in a generally upright position when not in use, and that, when in a stationary bicycle stand position, allows a traditional outdoor bicycle to also be used as a stationary bicycle, thereby eliminating the need to purchase both an outdoor bicycle and a stationary bicycle. Finally, there is a long felt need for a bicycle stand device that accomplishes all of the forgoing objectives, and that is relatively inexpensive to manufacture and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed herein, in one aspect thereof, is a bike stand device that may be removably attached to a traditional outdoor bicycle and easily repositioned between a bicycle stand or stationary bicycle stand position and a stored position. In a preferred embodiment of the present invention, the bicycle stand device is comprised of a pair of axle extenders, a bicycle stand and a repositioning pin, wherein said bicycle stand is further comprised of a base portion and two arm portions extending outwardly therefrom for attachment to said pair of axle extenders. In a preferred embodiment of the present invention, a non-slip material or pad may also be attached to the base portion of said bicycle stand to prevent the same from sliding or slipping on a surface when the bicycle is being stored or used as a stationary bicycle.

The bicycle stand device enables a user to (i) securely support a bicycle in a generally upright position without a kickstand when not in use; and (ii) temporarily covert a traditional outdoor bicycle into a stationary bicycle and vice versa, all without having to continuously install/remove cumbersome hardware from the bicycle. The bicycle stand device of the present invention also eliminates the need for a user to own and store two separate bicycles, namely an outdoor bicycle and a stationary bicycle, which can be expensive and consume too much storage space. Finally, the repositionable bicycle stand device of the present invention is relatively inexpensive to manufacture and safe and easy to install and use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a perspective view of a prior art bicycle.

FIG. 1A is a close-up perspective view of the rear wheel and axle assembly of a prior art bicycle.

FIG. 2 is a perspective exploded view of a preferred embodiment of the bicycle stand device of the present invention.

FIG. 3 is a perspective view of a preferred embodiment of the bicycle stand device of the present invention installed on the rear axle of a prior art bicycle and placed in a stationary bicycle stand position.

FIG. 3A is a perspective close-up view of a preferred embodiment of the bicycle stand device of the present invention installed on the rear axle of a prior art bicycle and placed in a stationary bicycle stand position.

FIG. 4 is a perspective view of a preferred embodiment of the bicycle stand device of the present invention installed on the rear axle of a prior art bicycle and placed in a stowed position.

FIG. 4A is a perspective close-up view of a preferred embodiment of the bicycle stand device of the present invention installed on the rear axle of a prior art bicycle and placed in a stowed position.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

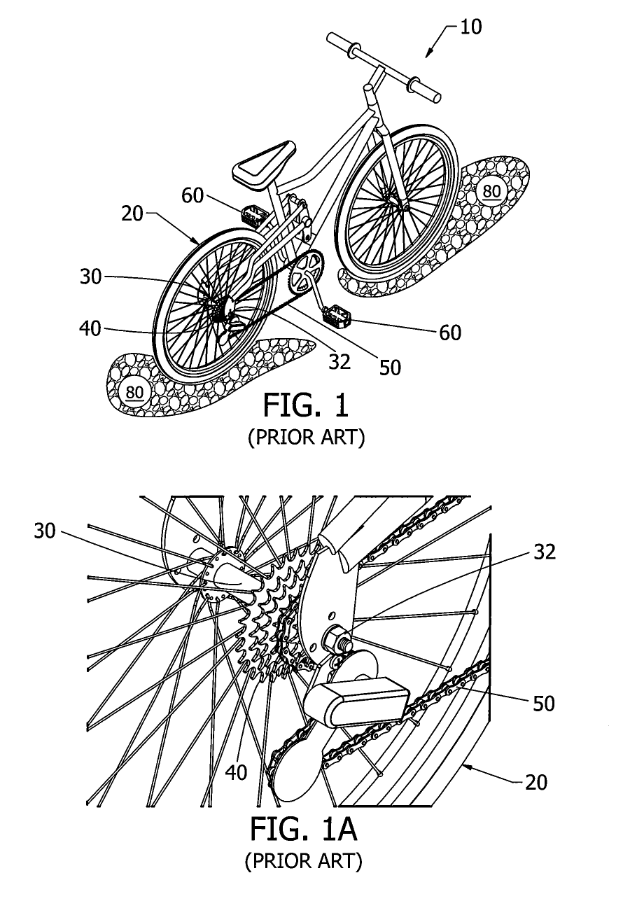

Referring initially to the drawings and by way of background, FIG. 1 illustrates a perspective view of a prior art bicycle 10. Prior art bicycles 10 are well known in the art and are available in various shapes, sizes and designs. Nonetheless, most prior art bicycles 10 are generally comprised of at least one wheel 20 that rotates about an axle 30 with an axle nut 32 and a washer 34 thereon, and that is powered by one or more gears 40 mechanically linked to a chain 50 that is, in turn, mechanically linked to a pedal 60 that is operated by the rider (not shown). More specifically, as the rider operates pedal 60, wheel 20 rotates about axle 30 and engages a ground surface 80 thereby propelling bicycle 10 along said surface 80.

Unfortunately, many bicycle enthusiasts are unable to enjoy their bicycle and the exercise associated therewith during periods of inclement weather and are forced to use a indoor stationary bicycle, which are also well known in the art. However, the cost and storage space requirements of owning both a traditional outdoor bicycle as well as an indoor stationary bicycle can be both expensive and overwhelming. Therefore, there is a long felt need for a bicycle stand device that can be removably attached to a bicycle and easily repositioned between a stationary bicycle stand position and a stored position, without having to remove the device from the bicycle.

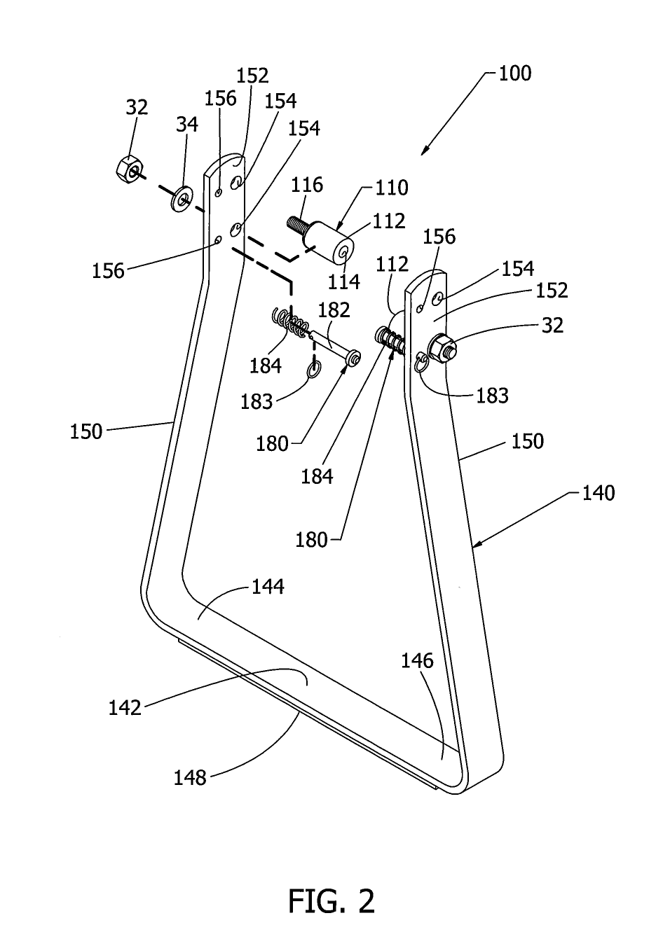

FIG. 2 is a perspective exploded view of a preferred embodiment of the bicycle stand device 100 of the present invention which is comprised of at least one and preferably two axle extenders 110, a bicycle stand 140 and a repositioning pin 180 for repositioning the bicycle stand 140 between a bicycle stand or stationary bicycle stand position and a stored position, as explained more fully below. Axle extender 110 is preferably an elongated member comprised of an inboard end 112 with a threaded opening 114 therein for receipt of a threaded end of axle 30, and a threaded outboard end 116. Inboard end 112 refers to the portion of axle extender 110 nearest to bicycle 10, and outboard end 116 refers to the opposite end of axle extender 110, which is furthest from bicycle 10. The overall length of axle extender 110, as measured from inboard end 112 to outboard end 116, is preferably between ½ and one inch, and the diameter of outboard end 116 should approximate the diameter of prior art axle 30 so that prior art washer 34 and threaded axle nut 32 can be attached thereto.

Axle extender 110 may be comprised of the same material used to manufacture prior art bicycle axle 30, though any other durable material may also be used without affecting the overall concept of the present invention. As explained more fully below, axle extenders 110 may be removably attached to each end of prior art axle 30, and bicycle stand 140 may then be removably attached to each of axle extenders 110 and secured thereto by prior art washer 34 and axle nut 32, as described more fully below. The primary purpose of axle extenders 110 is to ensure that bicycle stand 140 has sufficient clearance from prior art bicycle 10, and its various components, to be repositioned between a stored position and a bicycle stand position, and vice versa, without interference.

As best illustrated in FIG. 2, bicycle stand 140 is preferably comprised of a base portion 142 and a pair of spaced apart arm portions 150 extending outwardly from said base portion 142. Bicycle stand 140 is preferably comprised of a durable material such as metal (e.g., high strength steel), but can also be comprised of other materials such as plastic and the like provided that the same possess sufficient strength to support bicycle 10 and a rider when in the bicycle stand position, as explained more fully below. Bicycle stand 140 may be of unitary construction with bends at the intersections of base portion 142 with each arm portion 150, or arm portions 150 may be fixedly attached to said base portion 142 by any common means known in the art such as welding, fasteners, etc.

Base portion 142 further comprises a first end 144, a second end 146, and a pad 148. The overall length of base portion 142, as measured from first end 144 to second end 146, is preferably between 10 and 14 inches to increase the stability of device 100 and assure adequate clearance between arm portions 150 and bicycle 10. The purpose of pad 148 is to protect the surface beneath bicycle stand 140 from damage and to reduce the possibility of slippage or “walking” of base portion 140 across surface 80 when bicycle 10 is being stored or used as a stationary bicycle. Accordingly, pad 148 is preferably comprised of rubber, and is attached to and extends along most, if not all, of the length of base portion 142. Of course, other embodiments are also possible, for example, two or more rubber grips (not shown) could also be attached to base portion 142 in spaced apart fashion to serve the same function as pad 148 and in lieu of, or in addition to, pad 148.

As best illustrated in FIG. 2, each of arm portions 150 extend upwardly from the ends 144, 146 of said base portion 142 and the surface upon which it rests. Each of arm portions 150 are also further comprised of an upper end 152 and, in a preferred embodiment of the present invention, may have a slight bend or curvature so that the distance between said arm portions 150 is greatest at base portion 142 to increase the stability of the device, and smallest at the upper ends 152. For prior art bicycles 10 with wheels 20 measuring between 24 and 26 inches in diameter, the overall length of each arm portion 150, as measured from base portion 142 to upper end 152, is preferably between 14 and 16 inches to ensure that wheel 20 is suspended above base portion 142 and the ground 80 when device 100 is in a stationary bicycle stand position. Nonetheless, it is also contemplated that arm portions 150 may need to be manufactured to different dimensions or specifications to accommodate wheels 20 with different diameters. For example, a prior art wheel with a 29 inch diameter may require a device 100 with a longer arm portion 150 to ensure adequate clearance between wheel 20 and base portion 142 when bicycle stand 140 is in a stationary bicycle position, as described more fully below.

The upper end 152 of each of arm portions 150 may further comprise one or more continuous openings 154 therein for receipt of outboard end 116 of axle extender 110, as well as one or more continuous apertures 156 therein for receipt of repositioning pin 180. Opening 154 should be sized to accommodate the outboard end 116 of axle extender 110 and permit bicycle stand 140 to rotate thereabout. Additionally, as illustrated in the FIGS., more than one continuous opening 154 may be included on upper end 152 in spaced apart fashion to accommodate wheels 20 with different diameters (e.g., a 24 inch diameter wheel and a 26 inch diameter wheel, etc.), thereby enabling device 100 to be used with different sized bicycles 10. For example, for a bicycle with wheels measuring 24 inches in diameter, the location of opening 154 above the ground should be approximately one inch more than the radius of the wheel (i.e., 13 inches above the ground). Likewise, for a bicycle with wheels measuring 26 inches in diameter, the location of opening 154 above the ground should be approximately 14 inches.

Repositioning pin 180 may be any pin device that is known in the art, but is preferably a commercially available spring loaded pin device comprised of a pin 182, a ring 183 for activating repositioning pin 180, and a biased spring 184. Ring 183 and spring 184 enables pin 182 to be selectively moved between an engaged position and a disengaged position. More specifically, repositioning pin 180 is attached to the upper end 152 of one or both of arm portion 150 such that, when engaged, pin 182 extends through continuous aperture 156 and engages bicycle 10 to prevent bicycle stand 140 from being repositioned without first disengaging repositioning pin 180. More specifically, the frame members of bicycle 10 may form an existing opening or aperture for receipt of pin 182, or an opening may be created in the frame of bicycle 10 by any common means known in the art such as drilling.

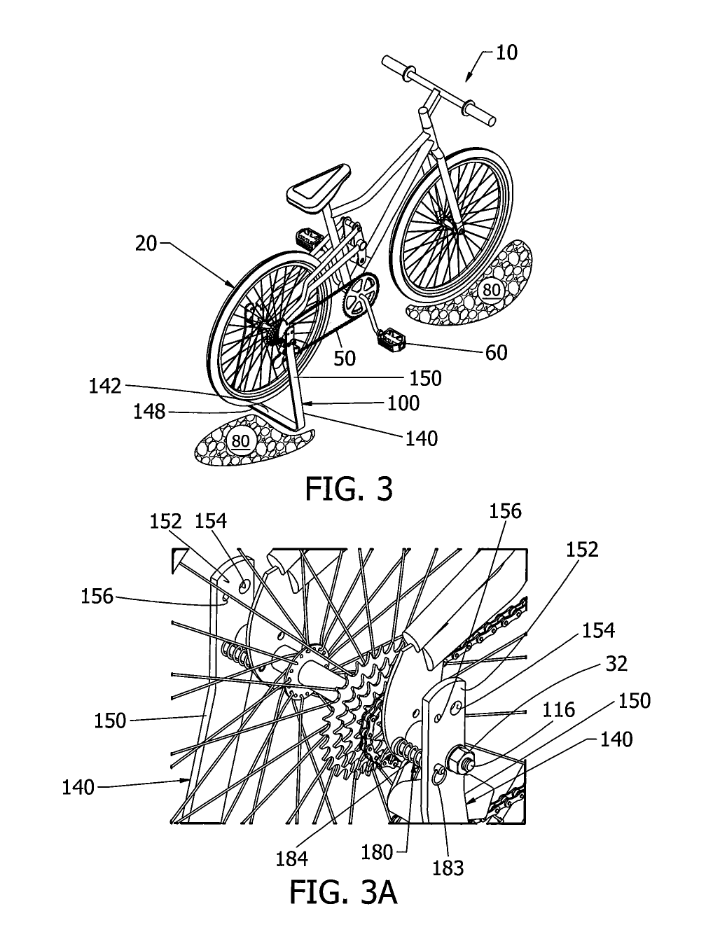

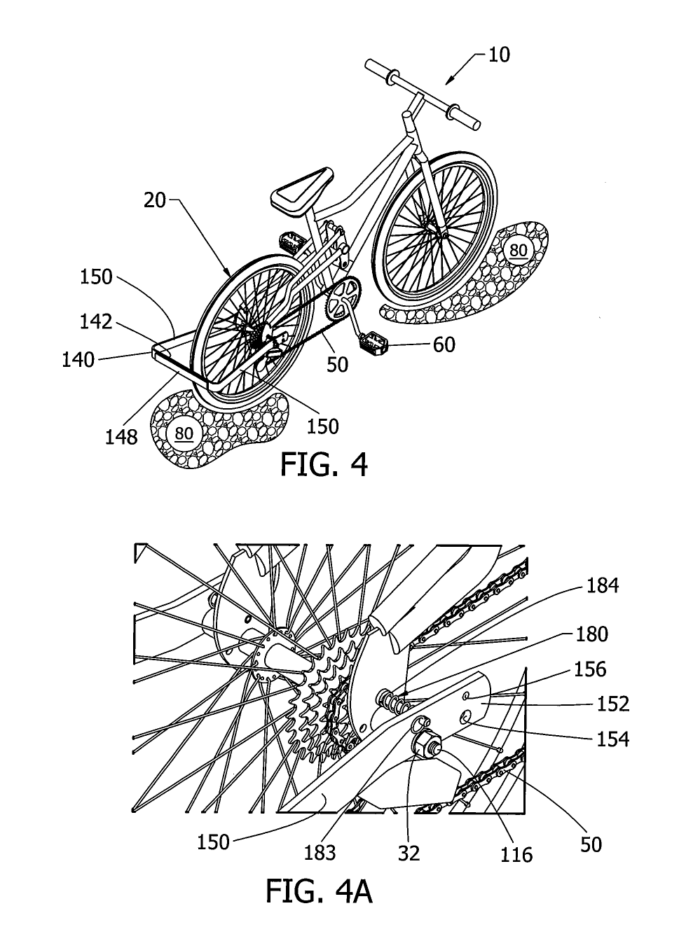

Having described the overall structure of repositionable bicycle stand device 100 of the present invention, it's use and usefulness will now be described. A user (not shown) desiring to attached device 100 to a prior art bicycle 10 would simply remove the existing axle nut 32 and washer 34 from each end of the rear axle 30, and install the axle extenders 110 to axle 30 (typically by screwing them onto the ends of axle 30). After the axle extenders 110 are installed on axle 30, a user can removably attach bicycle stand 140 to axle extenders 110 by inserting each axle extender 110 into a selected one of continuous openings 154 in arm portion 150 and attaching a prior art washer 34 and axle nut 32 to each outboard end 116 of axle extender 110. Once bicycle stand 140 is installed on the axle extenders 110, the user (not shown) may use repositioning pin 180 to selectively position bicycle stand 140 in a stationary bicycle stand position as depicted in FIGS. 3 and 3A, or a stowed position as depicted in FIGS. 4 and 4A.

In a stationary bicycle stand position, base portion 142 is in contact with ground surface 80 and prior art wheel 20 is suspended above said base portion 142, between each of arm portions 150, and is permitted to spin freely without engaging base portion 142 or ground surface 80. In this manner, a user may utilize prior art transportation bicycle 10 as a stationary bicycle and enjoy the bicycle throughout the year, including during periods of inclement weather when outdoor riding is not feasible. Further, when the user is again ready to utilize bicycle 20 in a traditional fashion or as a mode of transportation, the user can simply disengage repositioning pin 180, reposition bicycle stand 140 to a stowed position and re-engage repositioning pin 180—all without having to remove bicycle stand 140 from bicycle 20. In a stowed position, as illustrated in FIGS. 4 and 4A, base portion 142 of stand 140 is positioned behind, and out of the way of, wheel 20 so that wheel 20 is in contact with the ground 80 and bicycle 10 is capable of again being used as a means of transportation.

In this manner, the bicycle stand device of the present invention can be removably attached to a prior art bicycle and easily repositioned between a bicycle stand or stationary bicycle stand position and a stored position, without having to remove the device from the bicycle. The bicycle stand device is also capable of securely supporting a bicycle in a generally upright position when not in use, and that, when in a stationary bicycle stand position, allows a traditional outdoor bicycle to also be used as a stationary bicycle, thereby eliminating the need to purchase and store both an outdoor bicycle and a stationary bicycle. Finally, the repositionable bicycle stand device of the present invention is relatively inexpensive to manufacture and safe and easy to install and use.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A repositionable bicycle stand device for attachment to a bicycle with an axle and at least one wheel comprising:
at least one axle extender;
a bicycle stand; and
a repositioning pin.

2. The repositionable bicycle stand device of claim 1, wherein said bicycle stand further comprises a base portion and a pair of arm portions.

3. The repositionable bicycle stand device of claim 2, wherein said base portion further comprises a slip resistant material.

4. The repositionable bicycle stand device of claim 1, wherein said bicycle stand is repositionable between a stationary bicycle stand position and a stowed position.

5. The repositionable bicycle stand device of claim 1, wherein said bicycle stand is repositionable between a stationary bicycle stand position and a stowed position without detaching the bicycle stand from the bicycle.

6. The repositionable bicycle stand device of claim 2, wherein said at least one of said pair of arm portions is attached to the axle extender which is attached to the axle.

7. The repositionable bicycle stand device of claim 4, wherein said at least one wheel is powered by a pedal and elevated above a ground surface when the bicycle stand is in the stationary bicycle stand position.

8. The repositionable bicycle stand device of claim 4, wherein said at least one wheel is powered by a pedal and in contact with a ground surface when the bicycle stand is in the stowed position.

9. A repositionable bicycle stand device for attachment to a bicycle with an axle and at least one wheel that is powered by a chain comprising:
a pair of axle extenders;
a bicycle stand; and
a repositioning pin for repositioning the bicycle stand between a stationary bicycle stand position and a stowed position.

10. The repositionable bicycle stand device of claim 9, wherein said bicycle stand further comprises a base portion and a pair of arm portions.

11. The repositionable bicycle stand device of claim 10, wherein said base portion further comprises a slip resistant material.

12. The repositionable bicycle stand device of claim 9, wherein said bicycle stand is repositionable between a stationary bicycle stand position and a stowed position without detaching the bicycle stand from the bicycle.

13. The repositionable bicycle stand device of claim 10, wherein at least one of said pair of arm portions is attached to at least one of said pair of axle extenders which is attached to the axle.

14. The repositionable bicycle stand device of claim 9, wherein said at least one wheel is elevated above a ground surface when the bicycle stand is in the stationary bicycle stand position.

15. The repositionable bicycle stand device of claim 9, wherein said at least one wheel is in contact with a ground surface when the bicycle stand is in the stowed position.

16. A repositionable bicycle stand device for attachment to a bicycle axle with a wheel thereon comprising:
a first axle extender attached to said bicycle axle on a first side of said wheel;
a second axle extender attached to said bicycle axle on a second side of said wheel;
a bicycle stand further comprised of a base portion, a first arm portion and a second arm portion; and
a repositioning pin.

17. The repositionable bicycle stand device of claim 16, wherein said base portion further comprises a slip resistant material.

18. The repositionable bicycle stand device of claim 16, wherein the repositioning pin is used for repositioning the bicycle stand between a stationary bicycle stand position and a stowed position.

19. The repositionable bicycle stand device of claim 18, wherein said wheel is elevated above a ground surface when the bicycle stand is in the stationary bicycle stand position.

20. The repositionable bicycle stand device of claim 18, wherein said wheel is in contact with a ground surface when the bicycle stand is in the stowed position.
